(19) United States
(12) Patent Application Publication
(10) Pub. No.: US 2017/0328348 A1
(43) Pub. Date: Nov. 16, 2017

(54) SYSTEM AND METHOD FOR VALIDATING OPTIMIZATION OF A WIND FARM

(71) Applicant: General Electric Company, Schenectady, NY (US)

(72) Inventors: Megan Wilson, Greenville, SC (US); Stefan Kern, Munich (DE); Siddhanth Chandrashekar, Bangalore (IN); Dongjai Lee, Greer, SC (US); Sara Delport, Munich (DE); Akshay Ambekar, Mauldin, SC (US); Subhankar Ghosh, Bangalore (IN)

(21) Appl. No.: 15/151,573

(22) Filed: May 11, 2016

(51) Int. Cl. F03D 17/00; F03D 7/04; G05B 15/02

(52) U.S. Cl. CPC F03D 17/00; G05B 15/02; F03D 7/048; F05B 2270/20

(57) ABSTRACT

The present disclosure is directed to systems and methods for generating one or more farm-level power curves for a wind farm that can be used to validate an upgrade provided to the wind farm. The method includes operating the wind farm in a first operational mode. Another step includes collecting turbine-level operational data from one or more of the wind turbines in the wind farm during the first operational mode. The method also includes aggregating the turbine-level operational data into a representative farm-level time-series. Another step includes analyzing the operational data collected during the first second operational mode. Thus, the method also includes generating one or more farm-level power curves for the first operational mode based on the analyzed operational data.

### FIELD OF THE INVENTION

The present invention relates generally to wind farms, and more particularly, to systems and methods for validating optimization of a wind farm.

### BACKGROUND OF THE INVENTION

Wind power is considered one of the cleanest, most environmentally friendly energy sources presently available, and wind turbines have gained increased attention in this regard. A modern wind turbine typically includes a tower, a generator, a gearbox, a nacelle, and a rotor having one or more rotor blades. The rotor blades transform wind energy into a mechanical rotational torque that drives one or more generators via the rotor. The generators are sometimes, but not always, rotationally coupled to the rotor through the gearbox. The gearbox steps up the inherently low rotational speed of the rotor for the generator to efficiently convert the rotational mechanical energy to electrical energy, which is fed into a utility grid via at least one electrical connection. Such configurations may also include power converters that are used to convert a frequency of generated electric power to a frequency substantially similar to a utility grid frequency.

A plurality of wind turbines are commonly used in conjunction with one another to generate electricity and are commonly referred to as a “wind farm.” Wind turbines on a wind farm typically include their own meteorological monitors that perform, for example, temperature, wind speed, wind direction, barometric pressure, and/or air density measurements. In addition, a separate meteorological mast or tower (“met mast”) having higher quality meteorological instruments that can provide more accurate measurements at one point in the farm is commonly provided. The correlation of meteorological data with power output allows the empirical determination of a “power curve” for the individual wind turbines.

Traditionally, wind farms are controlled in a decentralized fashion to generate power such that each turbine is operated to maximize local energy output and to minimize impacts of local fatigue and extreme loads. To this end, each turbine includes a control module, which attempts to maximize power output of the turbine in the face of varying wind and grid conditions, while satisfying constraints like sub-system ratings and component loads. Based on the determined maximum power output, the control module controls the operation of various turbine components, such as the generator/power converter, the pitch system, the brakes, and the yaw mechanism to reach the maximum power efficiency.

However, in practice, such independent optimization of the wind turbines ignores farm-level performance goals, thereby leading to sub-optimal performance at the wind farm level. For example, downwind turbines may experience large wake effects caused by an upwind turbine. Because of these wake effects, downwind turbines receive wind at a lower speed, drastically affecting their power output (as power output increases with wind speed). Consequently, maximum efficiency of a few wind turbines may lead to sub-optimal power output, performance, or longevity of other wind turbines in the wind farm. Thus, modern control technologies attempt to optimize the wind farm power output rather than the power outputs of each individual wind turbine.

In addition, there are many products, features, and/or upgrades available for wind turbines and/or wind farms so as to increase power output or annual energy production (AEP) of the wind farm. Once an upgrade has been installed, it is advantageous to efficiently verify the benefit of the upgrade. For example, a typical method for assessing wind turbine performance measurements is to baseline power against wind speed as assessed by the turbine nacelle anemometer. The nacelle anemometer approach, however, is sometimes hindered due to imprecision of nacelle anemometer measurements and the projection of these measurements into AEP estimates. Further, such an approach may be less preferred than use of an external met mast in front of a wind turbine, but is in widespread use due to the generally prohibitive cost of the met mast approach. In addition, even when nacelle anemometers are calibrated correctly, individual wind power curve methods are not able to discern the benefit of upgrades, such as wake minimization technologies, that can create more wind for the farm to use.

Thus, a system and method for generating one or more farm-level power curves for a wind farm that can be used to validate an increase in energy production of a wind farm in response to one or more upgrades being provided thereto would be advantageous.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a method for generating one or more farm-level power curves for a wind farm that can be used to validate an upgrade provided to the wind farm. The method includes operating the wind farm in a first operational mode. Another step includes collecting turbine-level operational data from two or more of the wind turbines in the wind farm during the first operational mode. The method also includes aggregating the turbine-level operational data into a representative farm-level time-series. Another step includes analyzing the operational data collected during the first operational mode. Thus, the method also includes generating one or more farm-level power curves for the first operational mode based on the analyzed operational data.

In one embodiment, the step of aggregating the turbine-level operational data into a representative farm-level time-series may include utilizing at least one of data binning or regression analysis. In another embodiment, the step of analyzing the operational data collected during the first operational mode may include summing power generated by two or more of the wind turbines in the wind farm for the first operational mode.

In further embodiments, the method may further include operating the wind farm in a second operational mode, the second operational mode being characterized by one or more of the wind turbines being provided with the upgrade, collecting turbine-level operational data from one or more of the wind turbines in the wind farm during the first operational mode, aggregating the turbine-level operational data into a representative farm-level time-series, analyzing the operational data collected during the second operational mode, and generating one or more farm-level power curves for the first and second operational modes based on the analyzed operational data to assess a benefit of the upgrade.

In additional embodiments, the step of aggregating the turbine-level operational data into the representative farm-level time-series may include summing power generated by two or more of the wind turbines in the wind farm for the first operational mode and the second operational mode.

In another embodiment, the method may further include toggling or switching between the first and second operational modes and collecting operational data during each of the modes.

In yet another embodiment, the step of analyzing the operational data collected during the first and second operational modes may include mitigating loss of operational data. More specifically, in certain embodiments, the step of mitigating loss of operational data loss may include power scaling, sub-clustering, back-filling the operational data with historic data, evaluating uncertainty of the operational data, accounting for individual turbine operation states, or any other suitable method of mitigating data loss.

In further embodiments, the step of generating one or more farm-level power curves for the first operational mode (and/or the second operational mode) based on the analyzed operational data may include: binning the operational data collected during the first operational mode by wind direction into a plurality of wind sectors, excluding wind sectors with insufficient operational data, and generating a sector-specific farm-level power curve for non-excluded wind sectors.

In still additional embodiments, the method may include evaluating the farm-level energy production for the first operational mode based on at least one of the sector-specific farm-level power curves and an expected wind rose and Weibull distribution.

In another embodiment, the method may further include generating a predicted power curve for the first operational mode based on one or more simulated wind conditions prior to operating the wind farm in the first operational mode. In certain embodiment, the method may further include substituting actual measurement data in place of the simulated wind conditions where available during the first operational mode and, where measurement data is not available, adjusting the remaining simulated wind conditions via a realization factor.

In further embodiments, the method may include generating a test equivalent power curve based on observed wind conditions during the first operational mode and generating a farm-level power curve based on the predicted power curve and the test equivalent power curve.

In certain embodiments, the operational data as described herein may include any data of the wind farm and/or the individuals wind turbines, including but not limited to power output, generator speed, torque output, grid conditions, pitch angle, tip speed ratio, yaw angle, internal control set points, loading conditions, geographical information, temperature, pressure, wind turbine location, wind farm location, weather conditions, wind gusts, wind speed, wind direction, wind acceleration, wind turbulence, wind shear, wind veer, wake, or similar.

In particular embodiments, the upgrade(s) as described herein may include any one of or a combination of the following: a revised pitch or yaw angle, tip speed ratio, rotor blade chord extensions, software upgrades, controls upgrades, hardware upgrades, wake controls, aerodynamic upgrades, blade tip extensions, vortex generators, winglets, or any other suitable upgrades.

In another aspect, the present disclosure is directed to a method for validating a benefit of an upgrade provided to a wind farm having a plurality of wind turbines. The method includes operating the wind farm in a first operational mode for a first time period. The method also includes operating the wind farm in a second operational mode for a second time period, the second operational mode being characterized by one or more of the wind turbines being provided with the upgrade. Further, the method includes analyzing operational data collected during the first operational mode and the second operational mode. Another step includes generating one or more farm-level power curves for the first operational mode and the second operational mode based on the analyzed operational data. The method also includes determining a farm-level energy production for the first operational mode and the second operational mode based, at least in part, on the farm-level power curves for each mode. Thus, the method also includes evaluating the farm-level energy production for the first operational mode and the second operational mode to assess the benefit of the upgrade.

In yet another aspect, the present disclosure is directed to a system for validating a benefit of an upgrade provided to a wind farm having a plurality of wind turbines. The system includes a processor communicatively coupled to one or more sensors. The processor is configured to perform one or more operations, including but not limited to operating the wind farm in a first operational mode, collecting turbine-level operational data from one or more of the wind turbines in the wind farm during the first operational mode, aggregating the turbine-level operational data into a representative farm-level time-series, analyzing the operational data collected during the first operational mode, and generating one or more farm-level power curves for the first operational mode based on the analyzed operational data.

These and other features, aspects and advantages of the present invention will become better understood with reference the following description and appended claims. The accompanying drawings, which are incorporated in and constitute a part of this specification, illustrate the embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine;

FIG. 2 illustrates a schematic view of one embodiment of a controller for use with the wind turbine shown in FIG. 1;

FIG. 3 illustrates a schematic view of one embodiment of a wind farm according to the present disclosure;

FIG. 4 illustrates a flow diagram of one embodiment of a method for generating one or more farm-level power curves for a wind farm having a plurality of wind turbines that can be used to validate an upgrade provided to the wind farm according to the present disclosure.

FIG. 5 illustrates a schematic diagram of one embodiment of a wind turbine layout of a wind farm according to the present disclosure, particularly illustrating interacting groups or sub-clusters of wind turbines chosen as a function of wind direction and turbine spacing;

FIG. 6 illustrates a schematic diagram of one embodiment of a wind turbine layout of a wind farm according to the present disclosure, particularly illustrating how operational data can be back-filled with historic data;

FIG. 7 illustrates a flow diagram of one embodiment of a method for validating a benefit of an upgrade provided to a wind farm having a plurality of wind turbines according to the present disclosure;

FIG. 8 illustrates a graph of one embodiment of a cumulative farm-level power curve generated according to the present disclosure, particularly illustrating a linear portion of the cumulative farm-level power curve having a reduced range of wind speeds;

FIG. 9 illustrates a schematic diagram of one embodiment of a wind rose and Weibull distribution according to the present disclosure;

FIG. 10 illustrates one embodiment of a histogram of wind direction (x-axis) versus number of measured data points (y-axis) according to the present disclosure, particularly illustrating certain wind direction sectors being excluded due to lack of data availability;

FIG. 11 illustrates a graph of one embodiment of a sector-specific farm-level power curve according to the present disclosure; and

FIG. 12 illustrates a graph of one embodiment of energy production (x-axis) versus density (y-axis) for the first and second operational modes according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system and method for generating one or more farm-level power curves for a wind farm that can be used to validate an increase in energy production of a wind farm in response to one or more upgrades being provided thereto. At the farm-level, several inflow assumptions should be made before generating the farm-level power curves. Such inflow assumptions are not necessary for individual or single wind turbine power curve production. For example, the inflow wind direction may be assumed to be the median wind direction of all of the wind turbines in the wind farm. Further, the inflow wind speed may be the median of all of the freestream wind turbines, i.e. the forward-most wind turbines in the wind farm. In addition, farm-level wake losses are highly dependent on the turbine layout/wind direction and may also be considered when generating the farm-level power curve. Thus, in one embodiment, the method includes operating the wind farm in a first operational mode. Another step includes collecting turbine-level operational data from one or more of the wind turbines in the wind farm during the first operational mode and aggregating the turbine-level operational data into a representative farm-level time-series. The method also includes analyzing the operational data collected during the first operational mode. Thus, the method also includes generating one or more farm-level power curves for the first operational mode based on the analyzed operational data.

In another embodiment, the method may also include toggling between the first operational mode and a second, upgraded operational mode and collecting data during each mode. In such embodiments, the method may also include generating one or more farm-level power curves for each of the modes based on the analyzed operational data. Thus, the method may include determining a farm-level energy production for each mode based, at least in part, on the farm-level power curves for each mode and evaluating the farm-level energy production for each mode to assess a benefit of the upgrade.

The various embodiments of the system and method described herein provide numerous advantages not present in the prior art. For example, the present disclosure provides a system and method for generating farm-level power curves that can be used for assessment of expected energy production and/or performance differences between various modes of turbine operation. Validating farm-level performance, even in the absence of an upgraded operation mode has advantages. For example, an operator of a wind farm without upgrades, i.e. Running in baseline operation, may need to estimate expected energy production relative to a long-term wind resource. Conventional methods include using a single wind turbine power curve, e.g. Based on commercial power curves or even a measured power curvecollected at the site. The single turbine power curve must then be extrapolated to an expected farm-level production by accounting for additional farm-level considerations, e.g. wake interactions, which is often handled with simplified engineering models. In contrast, the farm-level power curves of the present disclosure account for such interactions intrinsically.

In addition, the present disclosure addresses data quality analysis at the farm level. Further, the present disclosure is configured to use the maximum amount of collected data, while ensuring that the data quality of the estimated energy production is not affected. Thus, the present system corrects data quality issues arising at a farm level, thereby addressing various challenges associated with farm level power curve estimation.

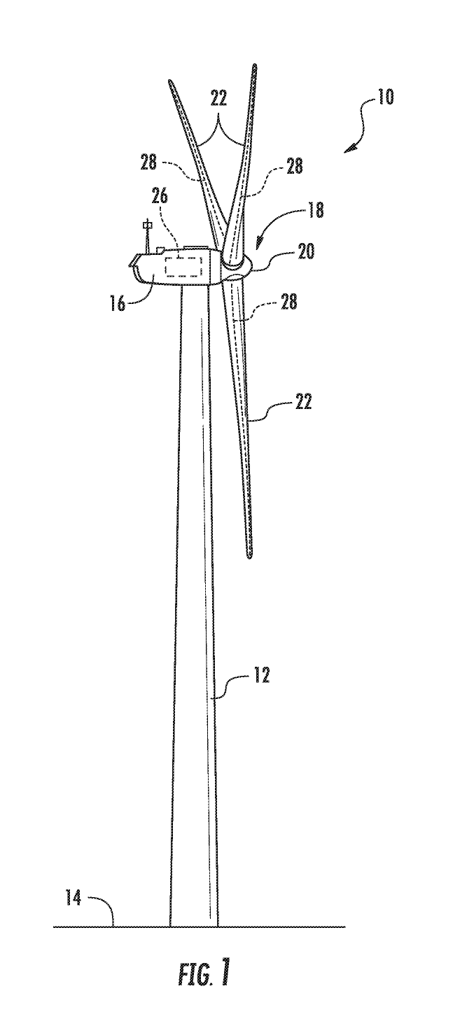

Referring now to the drawings, FIG. 1 illustrates a perspective view of one embodiment of a wind turbine 10 configured to implement the control technology according to the present disclosure. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

The wind turbine 10 may also include a wind turbine controller 26 centralized within the nacelle 16. However, in other embodiments, the controller 26 may be located within any other component of the wind turbine 10 or at a location outside the wind turbine. Further, the controller 26 may be communicatively coupled to any number of the components of the wind turbine 10 in order to control the operation of such components and/or to implement a control action. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals. Accordingly, the controller 26 may generally be configured to control the various operating modes of the wind turbine 10 (e.g., start-up or shut-down sequences), de-rate or up-rate the wind turbine 10, and/or control various components of the wind turbine 10. For example, the controller 26 may be configured to control the blade pitch or pitch angle of each of the rotor blades 22 (i.e., an angle that determines a perspective of the rotor blades 22 with respect to the direction of the wind) to control the power output generated by the wind turbine 10 by adjusting an angular position of at least one rotor blade 22 relative to the wind. For instance, the controller 26 may control the pitch angle of the rotor blades 22 by rotating the rotor blades 22 about a pitch axis 28, either individually or simultaneously, by transmitting suitable control signals to a pitch drive or pitch adjustment mechanism (not shown) of the wind turbine 10.

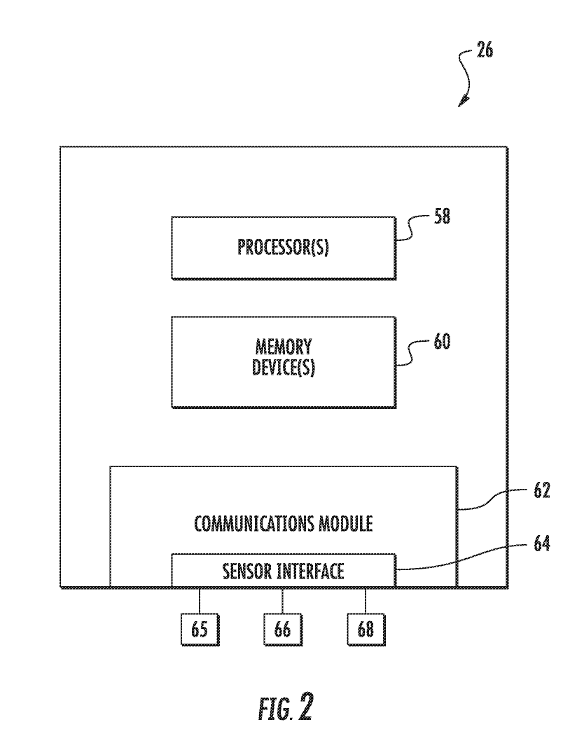

Referring now to FIG. 2, a block diagram of one embodiment of suitable components that may be included within the controller 26 is illustrated in accordance with aspects of the present disclosure. As shown, the controller 26 may include one or more processor(s) 58 and associated memory device(s) 60 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, application-specific processors, digital signal processors (DSPs), Application Specific Integrated Circuits (ASICs), Field Programmable Gate Arrays (FPGAs), and/or any other programmable circuits. Further, the memory device(s) 60 may generally include memory element(s) including, but are not limited to, computer readable medium (e.g., random access memory (RAM)), computer readable non-volatile medium (e.g., a flash memory), one or more hard disk drives, a floppy disk, a compact disc-read only memory (CD-ROM), compact disk-read/write (CD-R/W) drives, a magneto-optical disk (MOD), a digital versatile disc (DVD), flash drives, optical drives, solid-state storage devices, and/or other suitable memory elements.

Additionally, the controller 26 may also include a communications module 62 to facilitate communications between the controller 26 and the various components of the wind turbine 10. For instance, the communications module 62 may include a sensor interface 64 (e.g., one or more analog-to-digital converters) to permit the signals transmitted by one or more sensors 65, 66, 68 to be converted into signals that can be understood and processed by the controller 26. Furthermore, it should be appreciated that the sensors 65, 66, 68 may be communicatively coupled to the communications module 62 using any suitable means. For example, as shown in FIG. 2, the sensors 65, 66, 68 are coupled to the sensor interface 64 via a wired connection. However, in alternative embodiments, the sensors 65, 66, 68 may be coupled to the sensor interface 64 via a wireless connection, such as by using any suitable wireless communications protocol known in the art. For example, the communications module 62 may include the Internet, a local area network (LAN), wireless local area networks (WLAN), wide area networks (WAN) such as Worldwide Interoperability for Microwave Access (WiMax) networks, satellite networks, cellular networks, sensor networks, ad hoc networks, and/or short-range networks. As such, the processor 58 may be configured to receive one or more signals from the sensors 65, 66, 68.

The sensors 65, 66, 68 may be any suitable sensors configured to measure any operational data of the wind turbine 10 and/or wind parameters of the wind farm 200. For example, the sensors 65, 66, 68 may include blade sensors for measuring a pitch angle of one of the rotor blades 22 or for measuring a loading acting on one of the rotor blades 22; generator sensors for monitoring the generator (e.g. torque, rotational speed, acceleration and/or the power output); and/or various wind sensors for measuring various wind parameters (e.g. wind speed, wind direction, etc.). Further, the sensors 65, 66, 68 may be located near the ground of the wind turbine 10, on the nacelle 16, on a meteorological mast of the wind turbine 10, or any other location in the wind farm.

It should also be understood that any other number or type of sensors may be employed and at any location. For example, the sensors may be accelerometers, pressure sensors, strain gauges, angle of attack sensors, vibration sensors, MIMU sensors, camera systems, fiber optic systems, anemometers, wind vanes, Sonic Detection and Ranging (SODAR) sensors, infra lasers, Light Detecting and Ranging (LIDAR) sensors, radiometers, pitot tubes, rawinsondes, other optical sensors, and/or any other suitable sensors. It should be appreciated that, as used herein, the term “monitor” and variations thereof indicates that the various sensors of the wind turbine 10 may be configured to provide a direct measurement of the parameters being monitored or an indirect measurement of such parameters. Thus, the sensors 65, 66, 68 may, for example, be used to generate signals relating to the parameter being monitored, which can then be utilized by the controller 26 to determine the actual condition.

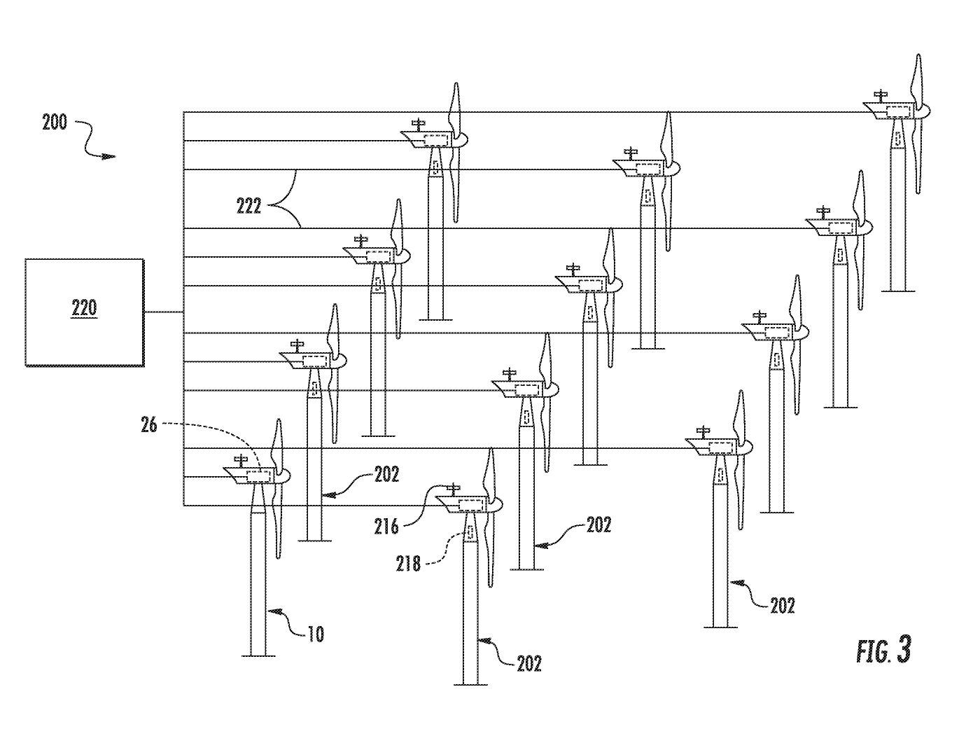

Referring now to FIG. 3, a wind farm 200 that is controlled according to the system and method of the present disclosure is illustrated. As shown, the wind farm 200 may include a plurality of wind turbines 202, including the wind turbine 10 described above, and a farm controller 220. For example, as shown in the illustrated embodiment, the wind farm 200 includes twelve wind turbines, including wind turbine 10. However, in other embodiments, the wind farm 200 may include any other number of wind turbines, such as less than twelve wind turbines or greater than twelve wind turbines. In one embodiment, the controller 26 of the wind turbine 10 may be communicatively coupled to the farm controller 220 through a wired connection, such as by connecting the controller 26 through suitable communicative links 222 (e.g., a suitable cable). Alternatively, the controller 26 may be communicatively coupled to the farm controller 220 through a wireless connection, such as by using any suitable wireless communications protocol known in the art. In addition, the farm controller 220 may be generally configured similar to the controllers 26 for each of the individual wind turbines 202 within the wind farm 200.

In several embodiments, one or more of the wind turbines 202 in the wind farm 200 may include a plurality of sensors for monitoring various operational data of the individual wind turbines 202 and/or one or more wind parameters of the wind farm 200. For example, as shown, each of the wind turbines 202 includes a wind sensor 216, such as an anemometer or any other suitable device, configured for measuring wind speeds or any other wind parameter. For example, in one embodiment, the wind parameters include information regarding at least one of or a combination of the following: a wind gust, a wind speed, a wind direction, a wind acceleration, a wind turbulence, a wind shear, a wind veer, a wake, SCADA information, or similar.

As is generally understood, wind speeds may vary significantly across a wind farm 200. Thus, the wind sensor(s) 216 may allow for the local wind speed at each wind turbine 202 to be monitored. In addition, the wind turbine 202 may also include one or more additional sensors 218. For instance, the sensors 218 may be configured to monitor electrical properties of the output of the generator of each wind turbine 202, such as current sensors, voltage sensors, temperature sensors, or power sensors that monitor power output directly based on current and voltage measurements. Alternatively, the sensors 218 may include any other sensors that may be utilized to monitor the power output of a wind turbine 202. It should also be understood that the wind turbines 202 in the wind farm 200 may include any other suitable sensor known in the art for measuring and/or monitoring wind parameters and/or wind turbine operational data.

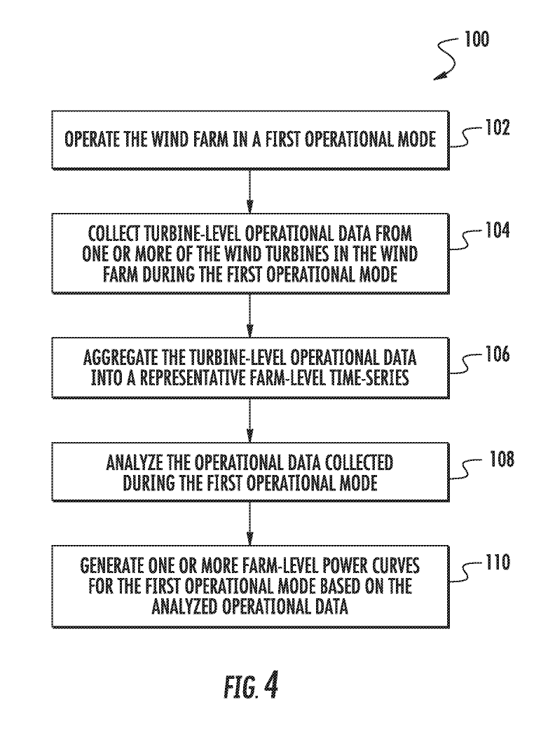

Referring now to FIG. 4, one embodiment of a method 100 for generating one or more farm-level power curves for a wind farm 200 having a plurality of wind turbines 202 that can be used to validate an upgrade provided to the wind farm 200 is illustrated. For example, in one embodiment, the farm controller 220 or the individual wind turbine controllers 26 may be configured to perform any of the steps of the method 100 as described herein. Further, in additional embodiments, the method 100 of the present disclosure may be performed manually via a separate computer not associated with the wind farm 200. As independent optimization of the wind turbines 202 may further actually decrease overall energy production of the wind farm 200, it is desirable to configure operation of the wind turbines 202 such that the farm-level energy output is increased.

Thus, as shown at 102, the method 100 includes operating the wind farm 200 in a first operational mode. As shown at 104, the method 102 includes collecting turbine-level operational data from one or more of the wind turbines 202 in the wind farm 200 during the first operational mode. For example, in certain embodiments, the wind farm 200 may be operated in the first operational mode for days, weeks, months, or longer. Thus, in certain embodiments, the controllers 26, 220 may be configured to collect operational data from each of the wind turbines 202 in the wind farm 200 during the first operational mode. In one embodiment, the wind parameters and/or the operational data may be generated via one or more of the sensors (e.g. via sensors 65, 66, 68, 216, 218, or any other suitable sensor). In addition, the wind parameters and/or the operational data may be determined via a computer model within the one of the controllers 26, 220 to reflect the real-time conditions of the wind farm 200.

Thus, the operational data is collected during each of the operational modes for further analysis. The operational data as described herein may include information regarding at least one of or a combination of the following: power output, generator speed, torque output, grid conditions, tip speed ratio, pitch angle, yaw angle, internal control set points, an operational state of the wind turbine, loading conditions, geographical information, temperature, date/time, pressure, wind turbine location, wind farm location, weather conditions, wind gusts, wind speed, wind direction, wind acceleration, wind turbulence, wind shear, wind veer, wake, or similar.

As shown at 106, the method 100 includes aggregating the turbine-level operational data into a representative farm-level time-series. Further, as shown at 108, the method 100 includes analyzing the operational data collected during the first operational mode. The controllers 26, 220 or separate computer (not shown) may be configured to aggregate and/or analyze the operational data in a variety of ways. For example, in one embodiment, one or more data quality algorithms may be utilized to process the operational data. In additional embodiments, the controllers 26, 220 may be configured to filter, average, and/or adjust the one or more operational data. More specifically, the data quality algorithms may be configured so as to filter one or more outliers, account for missing data points, and/or any other suitable processing steps. Thus, the data quality algorithms provide a framework to better manage the trade-off between data availability (e.g. by parameter, by time) and analysis quality.

The most basic approach for a farm-level power curve/energy assessment requires 100% of the turbines 202 in the wind farm 200 to simultaneously be operating such that each turbine 202 meets certain inclusion criteria. For example, in certain instances, the inclusion criteria may include any one or more of the following: in full/partial load, without any curtailment (both internal and external), standard deviation of wind speed at a reference turbine, or wind direction across all turbines, and without any other non-nominal behavior active (e.g. iced operation). In other words, if any one turbine 202 does not meet these inclusion criteria at a given time, that timestamp is thrown out for all turbines 202 causing a loss of usable operational data.

Thus, in certain embodiments, the step of analyzing the operational data collected during the various operational modes may include mitigating loss of operational data, e.g. due to farm-level filtering of individual wind turbine availability, curtailment, error in data transmission, non-normal wind turbine operation (such as during icing events), or any other data that is removed in single-wind-turbine power curve generation. More specifically, in certain embodiments, the step of mitigating loss of operational data loss may include power scaling, sub-clustering, back-filling the operational data with historic data, evaluating uncertainty of the operational data, accounting for individual turbine operation states, or any other suitable method of mitigating data loss.

Power scaling uses a scalar to scale-up the cumulative power of the wind turbines 202 that meet the inclusion criteria to a representative total farm-level power. In certain embodiments, for each time step, Equation (1) below can be used to determine the cumulative farm power:

$${P}_{F} = \frac{N}{n} {\sum }_{i = 1}^{n} {P}_{i} \qquad Equation ( 1 )$$

Where P_{F}=cumulative farm power,
Pᵢ=power from individual turbine,
N=total number of wind turbines in the wind farm, and
n=number of wind turbines that meet inclusion criteria.

Further, the controllers 26, 220 or separate computer may be configured to set a threshold of the wind farm 200 (i.e. a number of wind turbines) that must meet the inclusion criteria in order to use power scaling to maintain accuracy.

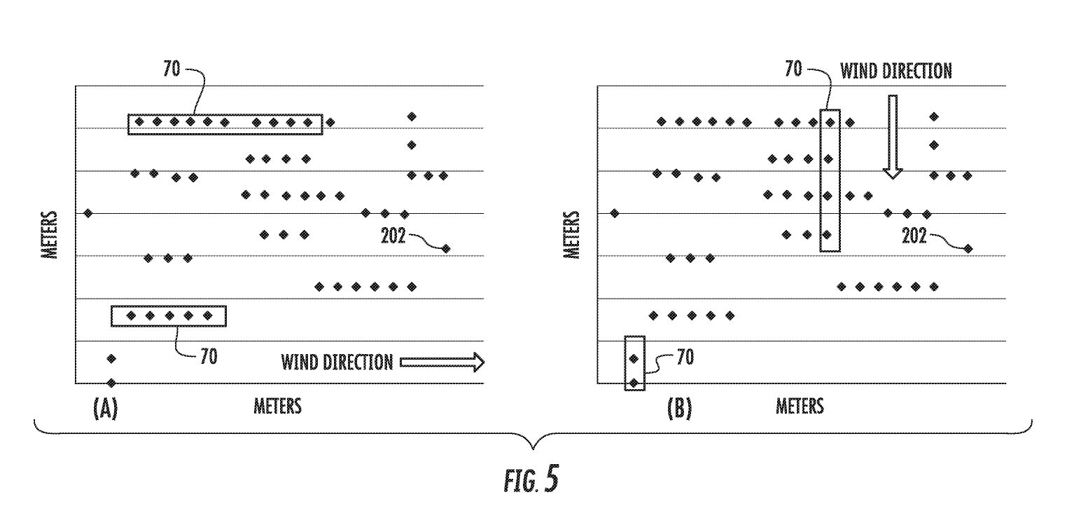

Sub-clustering involves dividing the wind farm 200 into smaller groups of interacting turbines 202, processing each group individually, and then summing or aggregating back up to farm-level. Sub-clusters may be chosen based on a variety of criteria, including for example, location of a wind turbine 202 in the wind farm 200 (i.e. upstream or downstream), wake interactions, geographical conditions, wind conditions, turbine type, or any other suitable criteria. Interacting groups of wind turbines 202 may vary as a function of wind direction and turbine spacing as shown in FIGS. 5(A) and 5(B). Thus, as shown, each wind turbine 202 can be assigned to a sub-cluster 70 based on interaction with neighboring wind turbines 202 for each wind direction. Isolated wind turbines 202 that do not interact can be in their own sub-group, i.e. with one turbine 202 in each group. Thus, if a wind turbine 202 does not pass the inclusion criteria, only that sub-cluster loses that point in the time-series, rather than the entire wind farm 200. As will be discussed in more detail below, for each wind direction, a power curve can be developed for each sub-cluster 70. The sub-cluster power curves can then be combined to equate to a farm-level power curve. Alternatively, a cluster of wind turbines 202 can be defined per wind turbine x. Thus, the cluster encloses all turbines that impact the performance of turbine x, for example due to wake effects or operational decisions. As the cluster per wind turbine is per definition smaller or equal to the above mentioned sub-cluster, more data can be retained. As such, the farm-level power curve can then be a combination of the turbine-level power curves.

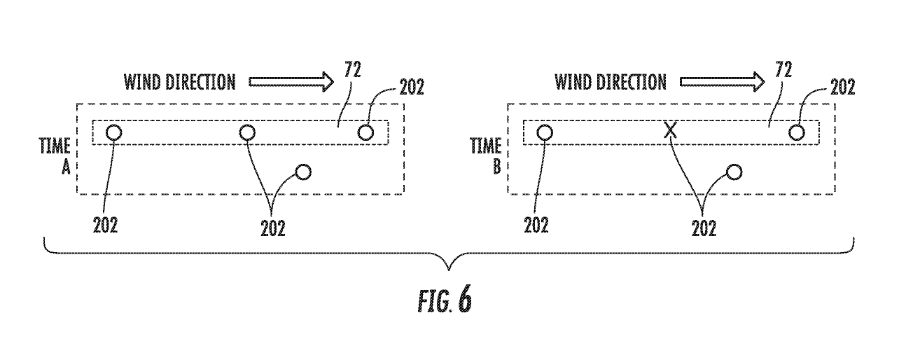

Back-filling the operational data generally refers to replacing missing data with surrogate data that is similar in nature. Further, back-filling the operational data with historic data can be better understood with reference to FIG. 6. More specifically, replacing a wind turbine 202 that fails the inclusion criteria with surrogate data from another time period representing either the same inflow or local conditions, allows for another method of mitigating loss of data. In a preferred embodiment, the wind turbine(s) 202 that fails the inclusion criteria and all interacting neighboring wind turbines 202 can be replaced with data from another time period representing the same inflow conditions. For example, as shown in FIG. 6, four neighboring wind turbines 202 are illustrated for two different time periods (i.e. Time A and Time B) having the same wind conditions (i.e. wind speed, wind direction, etc.). Only three of the wind turbines 202 are close enough to be considered neighbors as indicated by the dotted box 72. The only difference between Time A and Time B is that the middle turbine in Time B does not meet the inclusion criteria, as indicated by the X. As such, given the wind direction, the excluded turbine 202 has two neighbors it would interact with, and so all three turbines in Time B are replaced with power produced in Time A. It should be understood that such a substitution may be done on any size group of impacted turbines 202 in the wind farm 200 to mitigate data loss.

Referring back to FIG. 4, as shown at 110, the method 100 further includes generating one or more farm-level power curves for the first operational mode based on the analyzed operational data, which will be described in more detail below in reference to FIGS. 8-14.

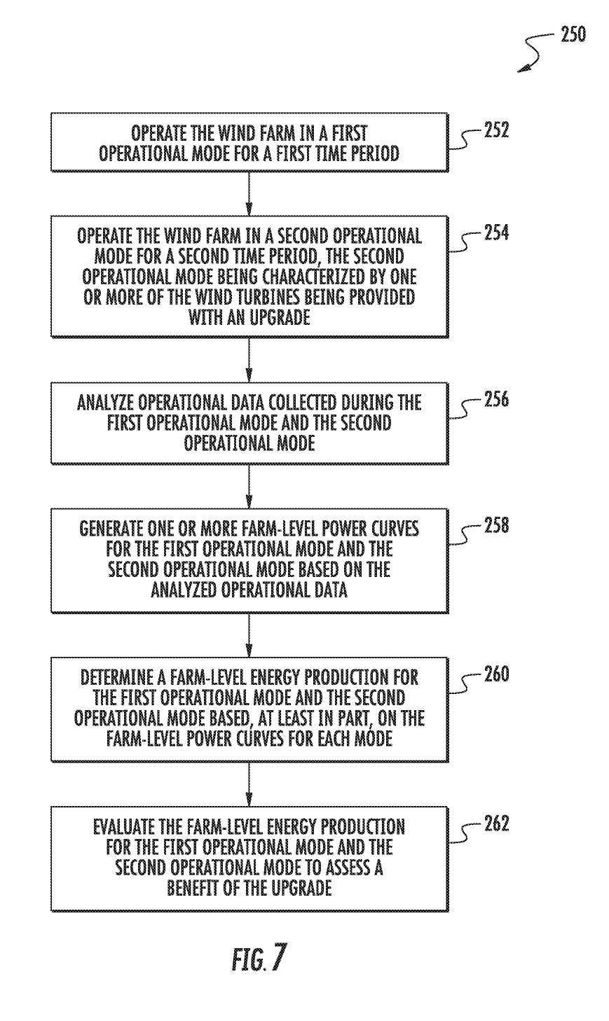

Referring now to FIG. 7, a flow diagram of one embodiment of a method 250 for validating a benefit, e.g. an increase in energy production, of a wind farm 200 in response to one or more upgrades being provided to one or more of the wind turbines 202 therein is illustrated according to the present disclosure. Thus, as shown at 252, the method 250 includes operating the wind farm 200 in a baseline or first operational mode for a first time period. As shown at 254, the method 250 also includes optionally operating the wind farm 200 in a second operational mode for a second time period. More specifically, the second operational mode is typically characterized by one or more of the wind turbines 202 being provided with an upgrade. As such, in certain embodiments, the farm controller 220 may operate the wind farm 200 by toggling between the first and second operational modes or may simply operate the wind farm 200 in a subsequent manner, i.e. by first operating in the first operational mode and then operating in the second operational mode.

Further, in particular embodiments, the upgrade(s) as described herein may include any one of or a combination of the following: revised pitch or yaw angles or tip speed ratio, rotor blade chord extensions, software upgrades, controls upgrades, hardware upgrades, wake controls, aerodynamic upgrades, blade tip extensions, vortex generators, winglets, or any other suitable upgrades.

More specifically, as shown at 256, the method 250 may include analyzing the operational data collected during the first operational mode and/or the second operational mode. It should be understood that the operational data may be analyzed according to any of the methods as described herein, for example, in reference to FIG. 4. As shown at 258, the method 250 may also include generating one or more farm-level power curves for the first and second operational modes based on the analyzed operational data. For example, as shown in FIG. 8, the method 250 may further include determining a cumulative farm-level power for the first operational mode 88 and optionally the second operational mode 90 based on the analyzed operational data, e.g. using power scaling, sub-clustering, or back-filling, and generating a farm-level power curve for each mode based on the cumulative farm-level power. In such an embodiment, the cumulative farm-level power for the first and the second operational modes may include a time-series cumulative farm-level power. Thus, as mentioned, the step of determining the time-series cumulative farm-level power for the first and second operational modes may include summing power generated by each wind turbine 202 in the wind farm 200 for the first and second operational modes at each time period.

In particular embodiments, the farm-level power curves 88, 90 for the first and/or second operational modes may be generated using data binning or regression analysis. For example, for regression analysis, the controllers 26, 220 or a separate computer may be configured to utilize a multi-parameter (e.g. four parameters) logistic cumulative distribution fit through data collected during the different operational modes. For data binning, the controllers 26, 220 may be configured to bin the operational data, e.g. in 0.5 meter/second (m/s) intervals or any other suitable internal. In addition, in one embodiment, the controllers 26, 220 are configured to use an average wind speed for each bin. It should be understood that either data binning or regression analysis may be implemented for bulk or sector-specific power curves, which will be described in more detail below. In addition, data binning or regression analysis may also require removal of outliers and/or limiting wind speed range to where sufficient data is available.

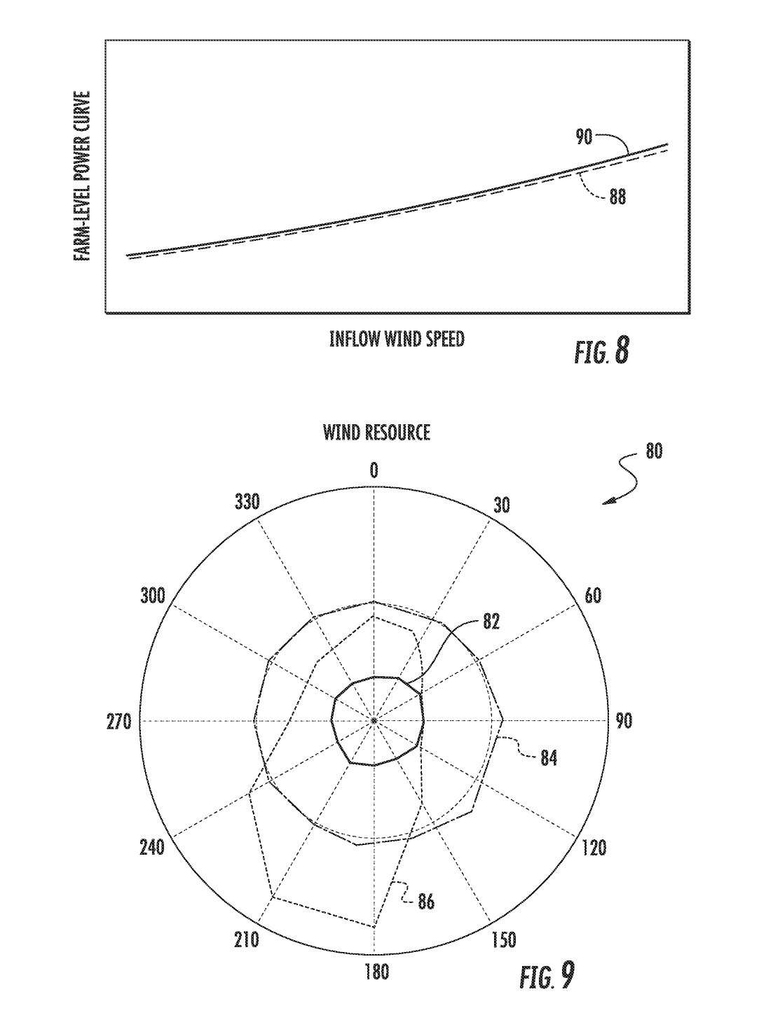

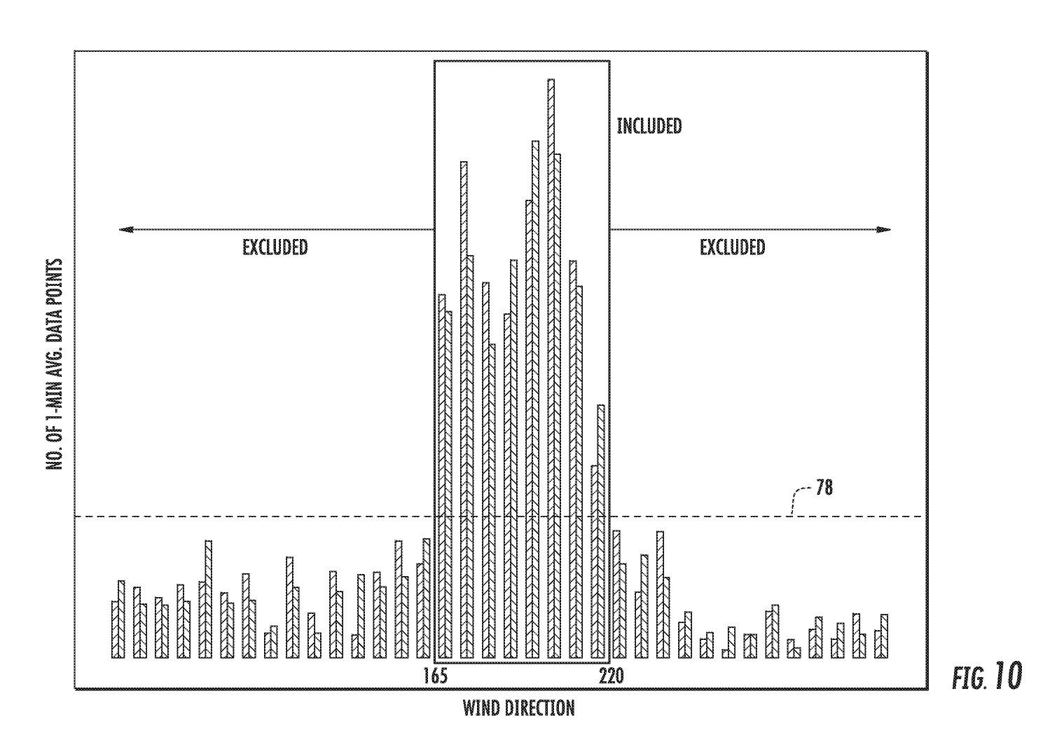

For example, in certain embodiments, the step of generating one or more farm-level power curves 88, 90 for the first and/or second operational modes based on the analyzed operational data may include binning the operational data from the first and/or second operational modes by wind direction into a plurality of wind sectors (FIGS. 10), excluding wind sectors with insufficient operational data (FIG. 10), and generating a sector-specific farm-level power curve for non-excluded wind sectors (FIG. 11). As used herein, a wind sector may be any size, including 1 degree up to 360 degrees. More specifically, as shown in FIG. 9, a wind rose and Weibull distribution 80 is illustrated particularly depicting the Weibull shape 82, the Weibull scale 84, and the frequency 86 of occurrence of a particular wind direction. Further, as shown in the illustrated example of FIG. 11, measurement-based results would only be shown for sectors 165°-220° due to limited data availability elsewhere. Moreover, as shown in FIG. 10, the minimum available data requirement or threshold 78 may be set such that any sector and/or wind speed bin not meeting the threshold 78 is excluded.

More specifically, farm-level power curves typically vary with respect to wind direction due to differences in wake loss as a function of turbine layout in the wind farm 200 as viewed from the incoming wind. As such, FIG. 11 illustrates a representative sector-wise farm-level power curve for the first operational mode. Further, FIG. 11 illustrates power curves for all thirty-six (36) sectors.

In yet another embodiment, the method 250 may include determining a predicted farm-level power curve for the first and/or second operational modes based on one or more estimated wind conditions prior to operating the wind farm in the different modes. As such, pre-test predictions are typically simulation-based only. As the wind farm 200 is operated in the different operational modes based on actual wind conditions, the controller(s) 26, 202 or a separate computer is configured to compare the predicted farm-level power curves with actual wind conditions collected during the first and/or second operational modes and create an equivalent farm-level power curve based on the comparison.

It is often desirable to adjust the initial simulation-based performance expectation as measurement data becomes available, thus, measurement data may substituted in place of pre-test predictions. Where such data is not available, measurement-based scaling may be substituted for all remaining pre-test predictions that are not directly replaced by measurement equivalents. Further, one or more assumptions can be made that if additional wind speeds and sectors had been observed, they would have exhibited an equivalent test-specific realization factor. This enables the remaining pre-test predictions that have not already been replaced by measurement to be scaled by the test-specific realization factor. More specifically, in certain embodiments, pre-test prediction data can be scaled using Equation (2) below:

S=P*R Equation (2)

Where S is the scaled value,
P is the predicted value for each bin, and
R is the realization factor, such as 0.5≦R≦1.3.

Thus, the realization factor is a ratio that represents how much benefit was observed between the first and/or second operational modes relative to the expectation or prediction. Similarly, a realization factor may be calculated and applied to the first and/or second operational mode directly. Further, in certain embodiments, the realization factor can be based on historic observation, as well as site/test-specific values. Realization factors may be calculated and/or applied in a number of ways, including but not limited to a single site-specific value, a single value derived from observation at one or more other wind farms, a site-specific wind speed bin-specific value derived from valid sectors at the test site, and/or a wind speed bin-specific observation at one or more other wind farms. Realization factors may also consider a number of other criteria as well, such as being representative of performance across the entire wind speed range over which the wind turbine operates, or be restricted to only consider and apply to a smaller range of wind speeds, and/or vary as a function of wind speed across the full or partial wind speed range over which the wind turbine operates.

Thus, Equation (3) represents one embodiment of using the realization factor to estimate a difference in energy production between operational modes using a measurement-based scalar:

ΔE=R(E₁—E₂) Equation (3)

Wherein ΔE is the additional energy production of the second operational mode,
R is the realization factor, such as 0.5≦R≦1.3,
E₁ is the energy production of the first operational mode, and
E₂ is the energy production of the second operational mode.

In additional embodiments, the controller(s) 26, 220 (as well as any other suitable processing means) is also configured to validate trends of the predictive model using the pre-test predictions. More specifically, in such embodiments, the measurement data is used as-is with no extrapolation. Thus, the controller(s) 26, 220 or separate computer is configured to generate a test equivalent prediction based on simulated sector-wise power curves and observed wind speeds and/or directions. The measured test and the test equivalent can then be used to generate a farm-level power curve for the first and/or second operational modes of the wind farm 200. A wind rose and Weibull distribution may be applied to each curve to estimate a representative energy contribution. Further, the controller(s) 26, 220 or separate computer may determine a gain for the first and/or second operational modes that can be assessed for both the measured test and the test equivalent. In certain embodiments, the controller(s) 26, 220 or separate computer may also determine a realization factor using Equation (4) below:

$$R = \frac{Measured Gain}{Test Equivalent Gain} \qquad Equation ( 4 )$$

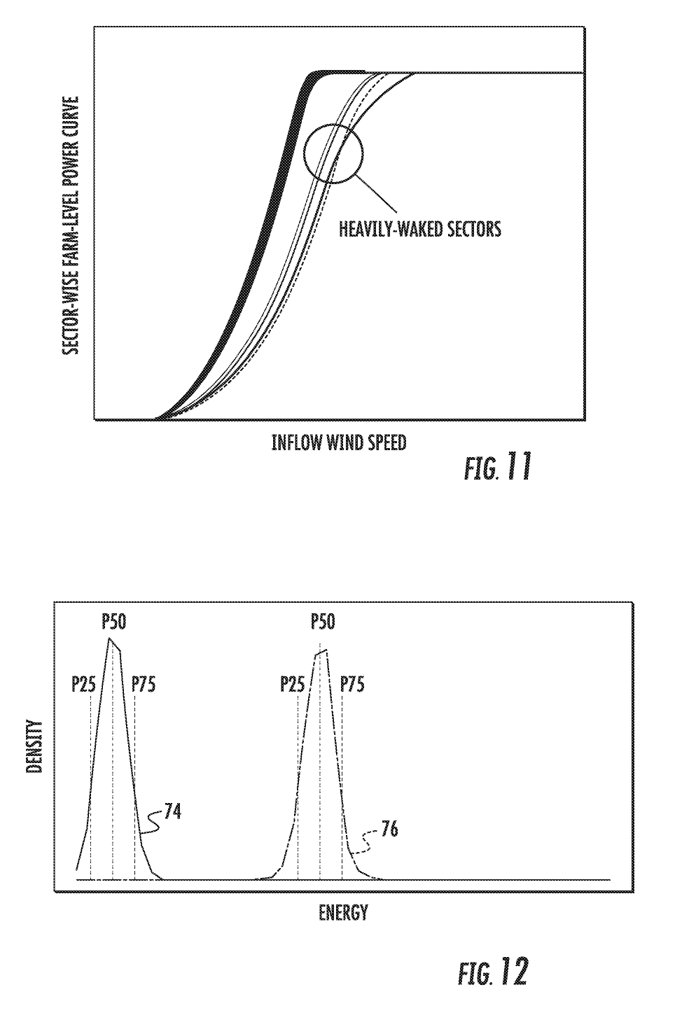

In additional embodiments, as mentioned, the controller(s) 26, 220 (as well as any other suitable processing means) is also configured to evaluate uncertainty of the operational data. For example, bootstrapping may be used to generate a plurality of power curve fits using data replicates to be used for uncertainty analysis. Further, these power curves used in conjunction with a wind resource assumption provides a plurality of energy values that can be viewed as an energy histogram (FIG. 12). If there is minimal or no overlap between the different operational modes, the result is statistically significant, i.e. a benefit of the second operational mode is realized. It should be understood that additional uncertainty methods may also be used in addition to bootstrapping.

After generating the power curves, the method 250 may also include determining a farm-level energy production for the first operational mode and the second operational mode based, at least in part, on the farm-level power curves for each mode as shown at 260 of FIG. 7. Thus, as shown at 262, the method 250 also includes evaluating the farm-level energy production for the first operational mode and the second operational mode to assess a benefit of the upgrade. More specifically, in certain embodiments, the method 100 may include evaluating the farm-level energy production for the first and second operational modes based on at least one of the sector-specific farm-level power curves and an expected wind rose and Weibull distribution. Thus, as shown in FIG. 12, the power curve (FIG. 8) and the expected wind rose and Weibull distribution (FIG. 9) may be used in conjunction to calculate the energy contribution for the first operational mode 74 and the second operational mode 76. For example, as shown in the illustrated embodiment, the second operational mode 76 produces more energy than the first operational mode 74, which is the desired outcome when one or more upgrades have been provided to the wind farm 200.

Exemplary embodiments of a wind farm, a controller for a wind farm, and a method for controlling a wind farm are described above in detail. The method, wind farm, and controller are not limited to the specific embodiments described herein, but rather, components of the wind turbines and/or the controller and/or steps of the method may be utilized independently and separately from other components and/or steps described herein. For example, the controller and method may also be used in combination with other power systems and methods, and are not limited to practice with only the wind turbine controller as described herein. Rather, the exemplary embodiment can be implemented and utilized in connection with many other wind turbine or power system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for generating one or more farm-level power curves for a wind farm having a plurality of wind turbines, the method comprising:
operating the wind farm in a first operational mode;
collecting turbine-level operational data from two or more of the wind turbines in the wind farm during the first operational mode;
aggregating the turbine-level operational data into a representative farm-level time-series;
analyzing the operational data collected during the first operational mode; and, generating one or more farm-level power curves for the first operational mode based on the analyzed operational data.

2. The method of claim 1, wherein analyzing the operational data collected during the first operational mode further comprises utilizing at least one of data binning or regression analysis.

3. The method of claim 1, wherein aggregating the turbine-level operational data into the representative farm-level time-series further comprises summing power generated by two or more of the wind turbines in the wind farm for the first operational mode.

4. The method of claim 1, further comprising:
operating the wind farm in a second operational mode, the second operational mode being characterized by two or more of the wind turbines being provided with the upgrade,
collecting turbine-level operational data from one or more of the wind turbines in the wind farm during the first operational mode,
aggregating the turbine-level operational data into a representative farm-level time-series,
analyzing the operational data collected during the second operational mode, and
generating one or more farm-level power curves for the first and second operational modes based on the analyzed operational data to assess a benefit of the upgrade.

5. The method of claim 4, further comprising toggling between the first and second operational modes and collecting turbine-level operational data during each of the modes.

6. The method of claim 1, wherein analyzing the operational data further comprises mitigating loss of operational data.

7. The method of claim 6, wherein mitigating loss of operational data comprises at least one of power scaling, sub-clustering, back-filling the operational data with historic data, evaluating uncertainty of the operational data, or accounting for individual turbine operation states.

8. The method of claim 1, wherein generating one or more farm-level power curves for the first operational mode based on the analyzed operational data further comprises:
binning the operational data from the first operational mode by wind direction into a plurality of wind sectors,
excluding wind sectors with insufficient operational data, and
generating a sector-specific farm-level power curve for non-excluded wind sectors.

9. The method of claim 8, further comprising evaluating a farm-level energy production for the first operational mode based on at least one of the sector-specific farm-level power curves and an expected wind rose and Weibull distribution.

10. The method of claim 1, further comprising generating a predicted power curve for the first operational mode based on one or more simulated wind conditions prior to operating the wind farm in the first operational mode.

11. The method of claim 10, further comprising:
during the first operational mode, substituting actual measurement data in place of the simulated wind conditions where available, and
where measurement data is not available, adjusting the remaining simulated wind conditions via a realization factor.

12. The method of claim 10, further comprising:
generating a test equivalent power curve based on observed wind conditions during the first operational mode, and
generating a farm-level power curve based on the predicted power curve and the test equivalent power curve.

13. The method of claim 1, wherein the operational data comprises information regarding at least one of or a combination of the following parameters:
power output, generator speed, torque output, grid conditions, pitch angle, tip speed ratio, yaw angle, internal control set points, loading conditions, geographical information, temperature, pressure, wind turbine location, wind farm location, weather conditions, wind gusts, wind speed, wind direction, wind acceleration, wind turbulence, wind shear, wind veer, or wake.

14. The method of claim 4, wherein the upgrade comprises any one of or a combination of the following: a revised pitch or yaw angle, tip speed ratio, rotor blade chord extensions, software upgrades, controls upgrades, hardware upgrades, wake controls, aerodynamic upgrades, blade tip extensions, vortex generators, or winglets.

15. A method for validating a benefit of an upgrade provided to a wind farm having a plurality of wind turbines, the method comprising:
operating the wind farm in a first operational mode for a first time period;
operating the wind farm in an second operational mode for a second time period, the second operational mode being characterized by one or more of the wind turbines being provided with the upgrade;
analyzing operational data collected during the first operational mode and the second operational mode;
generating one or more farm-level power curves for the first operational mode and the second operational mode based on the analyzed operational data;
determining a farm-level energy production for the first operational mode and the second operational mode based, at least in part, on the farm-level power curves for each mode; and,
evaluating the farm-level energy production for the first operational mode and the second operational mode to assess the benefit of the upgrade.

16. A system for generating one or more farm-level power curves for a wind farm having a plurality of wind turbines, the system comprising:
a processor communicatively coupled to one or more sensors, the processor configured to perform one or more operations, the one or more operations comprising:
operating the wind farm in a first operational mode,
collecting turbine-level operational data from two or more of the wind turbines in the wind farm during the first operational mode,
aggregating the turbine-level operational data into a representative farm-level time-series;
analyzing operational data collected during the first operational mode, and
generating one or more farm-level power curves for the first operational mode based on the analyzed operational data.

17. The system of claim 16, wherein analyzing the operational data collected during the first operational mode further comprises utilizing at least one of data binning or regression analysis.

18. The system of claim 16, wherein aggregating the turbine-level operational data into the representative farm-level time-series further comprises summing power generated by each wind turbine in the wind farm for the first operational mode.

19. The system of claim 16, wherein the one or more operations further comprise:
operating the wind farm in a second operational mode, the second operational mode being characterized by one or more of the wind turbines being provided with the upgrade,
collecting turbine-level operational data from one or more of the wind turbines in the wind farm during the first operational mode;
aggregating the turbine-level operational data into a representative farm-level time-series,
analyzing the operational data collected during the second operational mode, and
generating one or more farm-level power curves for the first and second operational modes based on the analyzed operational data to assess a benefit of the upgrade.

20. The system of claim 16, wherein analyzing the operational data collected during the first operational mode further comprises mitigating loss of operational data, wherein mitigating loss of operational data comprises at least one of power scaling, sub-clustering, back-filling the operational data with historic data, evaluating uncertainty of the operational data, accounting for individual turbine operation states.
